(19) United States
(12) Patent Application Publication
(10) Pub. No.: US 2026/0087432 A1
(43) Pub. Date: Mar. 26, 2026

(54) CLEANING PLANNING METHOD, ELECTRONIC DEVICE, AND STORAGE MEDIUM

(71) Applicant: HON HAI PRECISION INDUSTRY CO., LTD., New Taipei (TW)

(72) Inventors: Chih-Te Lu, New Taipei (TW); Chin-Pin Kuo, New Taipei (TW); Yu-Kai Zhou, New Taipei (TW)

(21) Appl. No.: 19/208,854

(22) Filed: May 15, 2025

(30) Foreign Application Priority Data
Sep. 25, 2024 (CN) 202411345024.0

(51) Int. Cl. G06Q 10/0631; G06Q 50/10

(52) U.S. Cl. CPC G06Q 10/06315; G06Q 50/10

(57) ABSTRACT

The present application provides a cleaning planning method, an electronic device and a storage medium. The method includes collecting cleaning resource information and environmental monitoring data of a plurality of areas that are to be cleaned. Once a sanitation status level of each of the plurality of areas is predicted based on the environmental monitoring data of each of the plurality of areas, at least one cleaning plan corresponding to the plurality of areas is generated according to the cleaning resource information and the sanitation status level of each of the plurality of areas.

### TECHNICAL FIELD

The present application refers to a technology field of smart city and relates to a cleaning planning method, an electronic device, and a storage medium.

### BACKGROUND

In order to maintain a cleanliness of an urban environment and health of residents, as well as to ensure a sanitation of a public space, it is particularly important to clean up garbage in a timely-and-efficient manner.

Generally, a garbage sweeper collects garbage according to a fixed route in a fixed time. However, when the garbage sweeper drives along the fixed route in the fixed time, the garbage sweeper may first drive to a garbage bin with less garbage, and then drive to a garbage bin that is full. This unreasonable cleaning plan results that the garbage in a garbage bin that is close to full or is full cannot be cleaned in time.

### BRIEF DESCRIPTION OF THE DRA WINGS

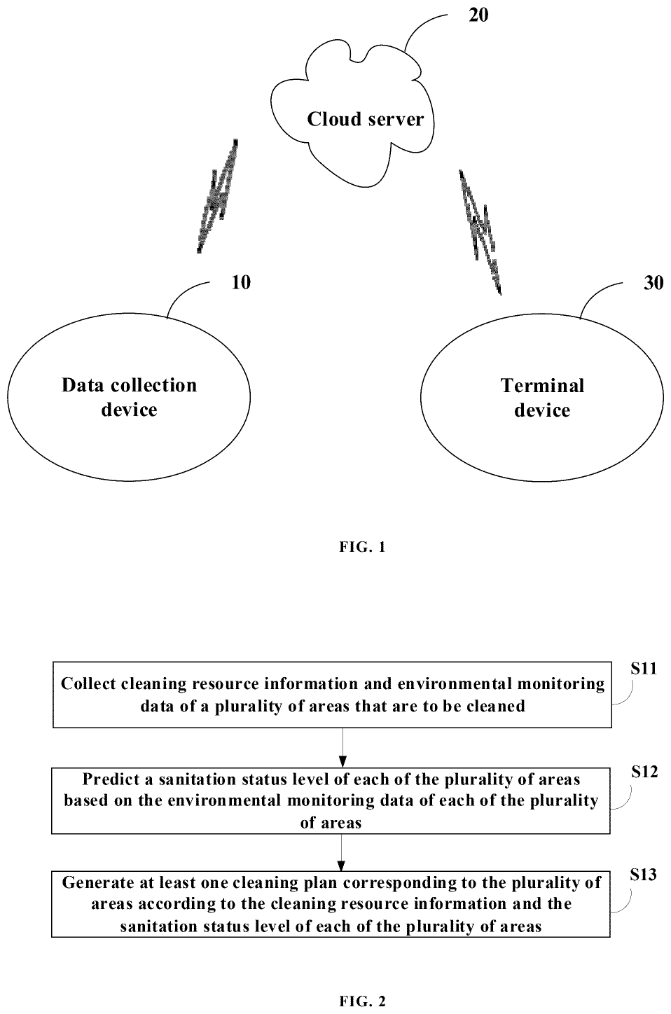

FIG. 1 is a schematic diagram of a cleaning planning system provided in an embodiment of the present application.

FIG. 2 is a flow chart of a cleaning planning method provided in an embodiment of the present application.

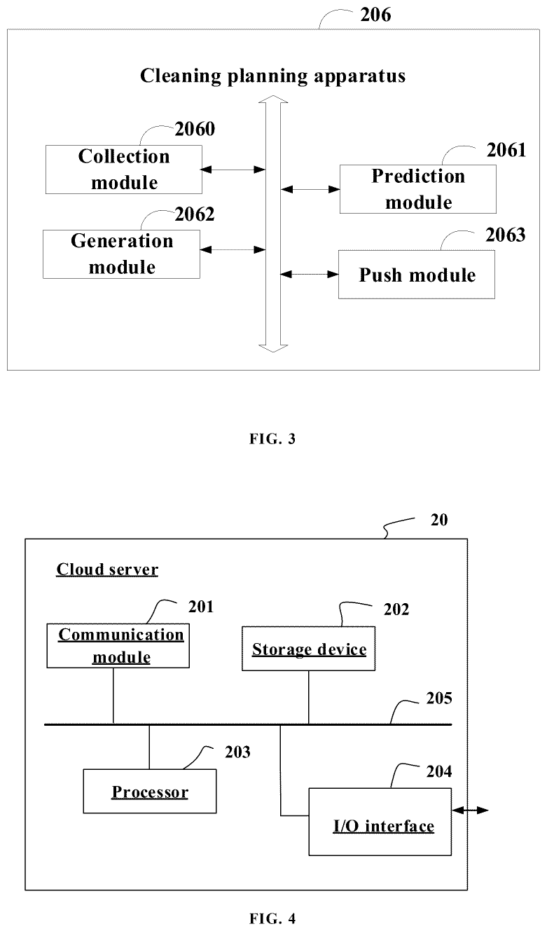

FIG. 3 is a diagram of functional modules of a cleaning planning apparatus provided in an embodiment of the present application.

FIG. 4 is a schematic diagram of a structure of a cloud server provided in an embodiment of the present application.

### DETAILED DESCRIPTION

It should be noted that in this application, “at least one” means one or more, and “more than one” means two or more than two. “And/or” describes an association relationship of associated objects, indicating that three relationships may exist. For example, A and/or B can mean: A exists alone, A and B exist at the same time, and B exists alone, where A and B can be singular or plural. The terms “first”, “second”, “third”, “fourth”, etc. (if any) in the specification, claims and drawings of this application are used to distinguish similar objects, rather than to describe a specific order or a specific sequence.

In the embodiments of the present application, words such as “exemplary” or “for example” are used to indicate examples, illustrations or descriptions. Any embodiment or design described as “exemplary” or “for example” in the embodiments of the present application should not be interpreted as being more preferred or more advantageous than other embodiments or designs. Specifically, use of words such as “exemplary” or “for example” is intended to present related concepts in a concrete way. The following embodiments and features in the embodiments may be combined with each other without conflict.

Embodiment of the present application provides a cleaning planning method, which can improve an efficiency of collecting garbage and ensure a clean environment. The cleaning planning method provided in the embodiment of the present application can be applied to one or more electronic devices, and the electronic device can be a server, a laptop, a mobile phone, a computer and other devices, where the server can be a cloud server or a server cluster, and the present application does not limit a type of the electronic device.

In order to facilitate a description of the cleaning planning method provided in the embodiment of the present application, following descriptions will be given using the electronic device being the cloud server as an example.

As shown in FIG. 1, it is a schematic diagram of a cleaning planning system provided in an embodiment of the present application. In FIG. 1, the cleaning planning system includes a data collection device 10, a cloud server 20, and a terminal device 30.

In some embodiments of the present application, the data collection device 10 is used to collect cleaning resource information and environmental monitoring data of multiple areas that are to be cleaned, and send the cleaning resource information and environmental monitoring data to the cloud server 20.

The cleaning resource information collected by the data collection device 10 may include human resource information and/or tool resource information. For example, the human resource information may include information such as a number of cleaning staff on duty, and the tool resource information may include information such as a location, a status, and a number of cleaning tools that are idle, and the cleaning tools include but are not limited to: a cleaning vehicle, a broom, a high-pressure water gun, a garbage shovel, and an object picking clamp.

The environmental monitoring data of each area includes one or more of environmental image data of each street of each area, real-time status data and historical status data of garbage in a garbage collection location of each street. The garbage collection location can be a coordinate or a coordinate range of a garbage recycling device, and the garbage recycling device can be a garbage can, a garbage bin, etc. The real-time status data of garbage can include one or more of a real-time weight of garbage, a real-time volume of garbage, a real-time height of garbage, etc. The historical status data of garbage can include one or more of a historical weight of garbage, a historical volume of garbage, a historical height of garbage, etc.

The data collection device 10 may include a group of devices for collecting cleaning resource information and environmental monitoring data. Exemplarily, the group of devices 10 may include an attendance machine for recording punch-in records of the cleaning staff, visual sensors for collecting environmental image data (for example, cameras and monitors, etc.), position sensors for obtaining information such as a position of cleaning tools such as the cleaning vehicle, ultrasonic sensors for obtaining the height of garbage, and weight sensors for obtaining the weight of garbage. The position sensor may be a global positioning system (GPS), the position sensor may be installed in the cleaning vehicle, and the ultrasonic sensor and the weight sensor may be installed in the garbage recycling device. The position of the cleaning tool may be a coordinate or a coordinate range of the cleaning tool. The above examples of the method for obtaining cleaning resource information and environmental monitoring data are only examples and are not limited to this in actual applications.

In some embodiments of the present application, the cloud server 20 is used to generate a cleaning plan for cleaning the multiple areas based on the cleaning resource information and environmental monitoring data, and send the cleaning plan to the terminal device 30.

The cloud server 20 can determine the number of cleaning staff on duty and other information based on the punch-in records that are received. Through the positions of the cleaning tools that are received, the cloud server 20 can determine the number, the positions, the status and other information of the cleaning tools that are idle. Exemplarily, through the received positions of the cleaning tools, the cloud server 20 can determine that the cleaning tools that are stationary within a preset time are cleaning tools that are idle, thereby determining the number and positions of the cleaning tools that are idle. Among them, the preset time can be customized. The above examples of the method for determining the information such as the number of cleaning staff on duty and the information such as the number, positions and statuses of idle cleaning tools are only examples, and are not limited to this in actual applications.

In other embodiments of the present application, the cloud server 20 may also obtain information such as the number, locations, and statuses of idle cleaning tools such as brooms, garbage shovels, and/or high-pressure water guns as cleaning resource information. Exemplarily, the cloud server 20 may obtain information such as the number, locations, and statuses of cleaning tools from an inventory management system of cleaning materials in each area, thereby determining information such as the number, locations, and statuses of cleaning vehicles, brooms, garbage shovels, and/or high-pressure water guns that are idle. Alternatively, a radio frequency identification (RFID) tag may be attached to each cleaning tool, and the cloud server 20 may track various cleaning materials through the RFID tag, thereby determining information such as the number, locations, and statuses of cleaning vehicles, brooms, garbage shovels, and/or high-pressure water guns that are idle.

In some embodiments of the present application, the cloud server 20 may store the cleaning resource information and environmental monitoring data that are received in a database. The processor of the cloud server 20 may generate a cleaning plan by obtaining the cleaning resource information and environmental monitoring data from the database. The database may include a historical database for storing historical data. When new cleaning resource information and new environmental monitoring data are received, the historical cleaning resource information and historical environmental monitoring data may be stored in the historical database. It should be noted that the new cleaning resource information can be defined as cleaning resource information that is obtained after the historical cleaning resource information. Correspondingly, the new environmental monitoring data can be defined as environmental monitoring data that is obtained after the historical environmental monitoring data.

In some embodiments of the present application, the terminal device 30 may be a screen display, a workstation, a server or other device of an environmental protection bureau of each area. For example, the screen display, the workstation, the server or other device may display the cleaning plan on a visual panel for a user to view. Alternatively, the terminal device 30 may also be a mobile phone, a computer or other device of an environmental protection staff member. The above examples of the terminal device 30 are only examples and are not limited thereto in actual applications.

The data collection device 10 and the cloud server 20 can be connected via a communication module, and the cloud server 20 and the terminal device 30 can be connected via a communication module. The communication module may be a wired communication module and/or a wireless communication module. The present application does not limit a type of the communication module.

In other embodiments of the present application, the data collection device 10 can send the cleaning resource information and the environmental monitoring data of the multiple areas to an external device that communicates with the cloud server 20 for storage, so that the cloud server 20 can obtain the cleaning resource information and the environmental monitoring data of the multiple areas from the external device, generate a cleaning plan based on the cleaning resource information and the environmental monitoring data, and send the cleaning plan to the terminal device 30.

FIG. 2, it is a flow chart of a cleaning planning method provided by an embodiment of the present application. According to different requirements, an order of each step in the flow chart can be adjusted according to actual requirements, and some steps can be omitted. The method is applied to a cloud server, such as the cloud server 20 shown in FIG. 4.

S11, cleaning resource information and environmental monitoring data of multiple areas that are to be cleaned are collected.

In some embodiments of the present application, the cleaning resource information may include human resource information and/or tool resource information, and the environmental monitoring data of each area includes one or more of environmental image data of each street of each area, real-time status data and historical status data of garbage in the garbage collection location. The historical status data of the garbage can be obtained by querying from the historical database.

Exemplarily, the environmental monitoring data of each area may include environmental image data of the street and real-time status data of garbage, or the environmental monitoring data of each area may include real-time status data and historical status data of garbage.

For the description of cleaning resource information and environmental monitoring data, please refer to the above description, and this application will not repeat the description.

In this embodiment, the environmental monitoring data of the area can reflect a sanitary status of the area, and the cleaning resource information can reflect available cleaning resources.

S12, a sanitation status level of each area is predicted based on the environmental monitoring data of each area.

In some embodiments of the present application, for each area, the cloud server can obtain multiple features by performing a feature extraction on the environmental monitoring data of each area using a neural network model; determine a feature vector based on the multiple features; obtain confidence levels corresponding to multiple preset sanitation levels for each area by predicting based on the feature vector, and determine the sanitation status level of each area from the multiple preset sanitation levels based on the confidence levels.

The preset sanitation level may indicate a degree of dirtiness of a sanitation status. The multiple preset sanitation levels may be customized, and the present application does not limit this. Exemplarily, the multiple preset sanitation levels may include no dirtiness, low dirtiness, medium dirtiness, and extreme dirtiness, where the degrees of dirtiness corresponding to no dirtiness, low dirtiness, medium dirtiness, and extreme dirtiness may increase in sequence. The sanitation status level of each area may be corresponding to a preset time period. Exemplarily, the preset time period may be a future day.

Among them, the neural network model may include a feature extraction module and a classification module. The feature extraction module may include but is not limited to: network layers such as a convolution layer, a pooling layer, a fully connected layer, a batch normalization layer and an activation function layer. Parameters such as a size, a step size and a padding number of a convolution kernel in the convolution layer and parameters such as a weight matrix and a bias vector in the fully connected layer can be customized. The classification module may include a fully connected layer and an activation function. The fully connected layer may include a weight matrix and a bias vector, and each row element value or each column element value in the weight matrix corresponds to a preset sanitation level.

If the environmental monitoring data of each area includes environmental image data of the street and real-time status data of garbage, the multiple features may include features corresponding to the environmental image data and features corresponding to the real-time status data. Alternatively, if the environmental monitoring data of each area includes real-time status data and historical status data of garbage, the multiple features may include features corresponding to the real-time status data of garbage and features corresponding to the historical status data of garbage. The features corresponding to the environmental image data may be extracted through the network layer such as the convolutional layer, and the features corresponding to the real-time status data and historical status data may be extracted through the network layer such as the fully connected layer.

Exemplarily, the cloud server splices the multiple features corresponding to each area to obtain the feature vector corresponding to each area. The cloud server can multiply the feature vector with the weight matrix in the classification layer to obtain a multiplied vector, add the multiplied vector with the bias vector in the classification layer to obtain an original score corresponding to each preset sanitation level for each area, and obtain the confidence level/probability corresponding to each preset sanitation level for each area based on an formula of the activation function and the original score corresponding to each preset sanitation level. Each confidence level can be in a range of 0 to 1.

For example, a method for calculating the confidence level/probability corresponding to each preset sanitation level for each area can refer to a formula (1):

$${P}_{i} = \frac{{e}^{{z}_{i}}}{{\sum }_{j = 1}^{C} {e}^{{z}_{j}}} ; \qquad ( 1 )$$

Where, for each area, Pᵢ represents a confidence level/probability corresponding to the ith preset sanitation level, zᵢ represents the original score corresponding to the ith preset sanitation level; C represents the number of multiple preset sanitation levels, and zⱼ represents the original score corresponding to the jth preset sanitation level.

According to the confidence level of each area corresponding to each preset sanitation level, multiple confidence levels corresponding to each area can be obtained. Among the multiple confidence levels corresponding to each area, the cloud server can determine that the preset sanitation level corresponding to the highest confidence level is the sanitation status level of each area.

In some embodiments of the present application, the cloud server may obtain a neural network model by training a neural network, where the neural network may include but is not limited to: deep learning networks such as a convolutional neural network (CNN) and a recurrent neural network (RNN). The convolutional neural network may be a network such as LeNet, AlexNet, ResNet, etc., and the present application does not limit this.

The training of the neural network model includes: the cloud server obtains multiple environmental sample data and a label corresponding to each environmental sample data, the label being used to indicate the preset sanitation level of each environmental sample data; and training a preset neural network according to the multiple environmental sample data and the label corresponding to each environmental sample data to obtain the neural network model.

For the description of environmental sample data, please refer to the above description of environmental monitoring data.

The cloud server can encode the label corresponding to each environmental sample data based on multiple preset sanitation levels to obtain an encoding vector corresponding to each environmental sample data. The present application does not limit the encoding method. For example, the cloud server can encode the label corresponding to each environmental sample data based on multiple preset sanitation levels. In the encoding vector corresponding to each environmental sample data, an encoding value corresponding to the preset sanitation level indicated by the label corresponding to each environmental sample data in the encoding vector can be a value of 1, and the encoding values corresponding to other preset sanitation levels in the encoding vector except the preset sanitation level indicated by the label corresponding to each piece of environmental sample data can be a value of 0.

By inputting multiple environmental sample data into a neural network for prediction, the confidence levels of each environmental sample data corresponding to multiple preset sanitation levels can be obtained, thereby obtaining multiple confidence levels corresponding to each environmental sample data. A prediction loss of the neural network is calculated based on the encoding vector and multiple confidence levels corresponding to each environmental sample data using a preset loss function. Network parameters of the neural network are adjusted according to the predicted loss until a loss value is within a preset range, thereby obtaining a neural network model.

Among them, the preset loss function can be a cross entropy loss, and this application does not limit the type of the preset loss function. The network parameters of the neural network can be a learning rate, a weight, and a bias. The preset range can be customized. For example, the preset range can be a range of 0 to 1.

For example, the calculation method of the prediction loss can refer to the following formula (2):

$$L = - {\sum }_{n = 1}^{N} {\sum }_{i = 1}^{C} {y}_{in} log ( {P}_{in} ) ; \qquad ( 2 )$$

Among them, L represents the predicted loss, N can represent a number of multiple environmental sample data, C represents a number of multiple preset sanitation levels, yᵢₙ represents the coding value of the nth environmental sample data corresponding to the ith preset sanitation level in the coding vector corresponding to the nth environmental sample data, and Pᵢₙ represents the confidence level that the nth environmental sample data corresponds to the ith preset sanitation level.

In this embodiment, the sanitation status level can reflect a severity/dirtiness of the sanitation status of the area. By predicting the environmental monitoring data through a neural network, the sanitation status level of each area can be accurately determined.

S13, a cleaning plan corresponding to the multiple areas are generated according to the cleaning resource information and the sanitation status levels of the multiple areas.

In some embodiments of the present application, the cloud server generates the cleaning plan corresponding to multiple areas based on the cleaning resource information and the sanitation status levels of the multiple areas, including: generating a cleaning planning task based on the cleaning resource information and the sanitation status levels of the multiple areas; and obtaining the cleaning plan using a language model according to the cleaning planning task.

In some embodiments of the present application, the cloud server generates the cleaning plan corresponding to multiple areas based on the cleaning resource information and the sanitation status levels of the multiple areas, including: generating a cleaning planning task based on preset prompt information, the cleaning resource information and the sanitation status levels of the multiple areas, the preset prompt information being used to prompt a generation of the cleaning plan based on the cleaning resource information and the sanitation status levels of the multiple areas; and inputting the cleaning planning task into a language model to obtain the cleaning plan.

Among them, the prompt information can be customized, and this application does not impose any restrictions on this.

This application does not limit a type of the language model. For example, the language model can be GPT4, ChatGLM, BERT, Qwen-14B, Baichuan-7B, Qwen-7B and other models.

Exemplarily, the cloud server can determine cleaning planning information based on a semantic analysis of the cleaning planning task, where the cleaning planning information includes but is not limited to: a cleaning order of multiple areas, the cleaning resource information required by each area and/or cleaning time information of each area, and generate the cleaning plan based on the cleaning planning information.

For example, the cleaning order corresponding to the area with a higher degree of dirtiness may be prioritized over the cleaning order corresponding to the area with a lower degree of dirtiness. The cleaning resource information required for each area may be the number of cleaning staff, cleaning vehicles, brooms and other cleaning tools required by each area. The cleaning time information for each area may be the cleaning start time and an estimated cleaning duration of each area.

For example, if the areas include A, B, and C, the environmental image data corresponding to the streets in areas A, B, and C and a real-time weight of garbage, a real-time volume of garbage, and a real-time height of garbage of a garbage can are predicted through the neural network model to obtain the sanitation status levels of areas A, B, and C. If the sanitation status level of the area A is no dirtiness, the sanitation status level of the area B is low dirtiness, and the sanitation status level of the area C is extremely dirtiness, a cleaning planning task is generated based on the idle cleaning staff, the idle cleaning vehicles, and the sanitation status levels of areas A, B, and C, and the cleaning planning task is input into the language model, and the cleaning plan that can be obtained is that 2 cleaning staff and 1 cleaning vehicle need to be dispatched to sequentially clean areas C, B, and A to recycle and clean the garbage cans.

For example, if the areas include D, E, and F, the sanitation status level of the area D is predicted according to a historical weight of garbage, a real-time weight of garbage, a historical volume of garbage, a real-time volume of garbage, a historical height of garbage, and a real-time height of garbage of the garbage bin on the street of the area D through the neural network model. The sanitation status level of the area E is predicted according to a historical weight of garbage, a real-time weight of garbage, a historical volume of garbage, a real-time volume of garbage, a historical height of garbage, and a real-time height of garbage of the garbage bin on the street of the area E through the neural network model. The sanitation status level of the area Fis predicted according to a historical weight of garbage, a real-time weight of garbage, a historical volume of garbage, a real-time volume of garbage, a historical height of garbage, and a real-time height of garbage of the garbage bin on the street of the area F through the neural network model. If the sanitation status level of the area D is extremely dirtiness, the sanitation status level of the area E is medium dirtiness, and the sanitation status level of area Fis no dirtiness, a cleaning planning task is generated based on idle cleaning staff, idle cleaning vehicles, idle garbage shovels, and the sanitation status levels of the areas D, E, and F, and the cleaning planning task is input into the language model. The cleaning plan that can be obtained indicates that 6 cleaning staff, 2 cleaning vehicles, and tools such as picking clips and brooms need to be dispatched to sequentially clean garbage in areas D, E, and F.

In some implementations of the present application, if there is one single cleaning plan is generated, the cloud server can send the cleaning plan to a terminal device (such as the terminal device 30 shown in FIG. 1) that is communicatively connected to the cloud server. If there are multiple cleaning plans, the cloud server can determine a target cleaning plan from the multiple cleaning plans and send the target cleaning plan to the terminal device. Exemplarily, the cloud server can randomly select one cleaning plan from the multiple cleaning plans as the target cleaning plan, or the cloud server can determine the cleaning plan that takes a least duration to clean as the target cleaning plan. The above examples of the method for selecting the target cleaning plan are only examples and are not limited to this in actual applications.

In this embodiment, by utilizing the language model to make decisions on the cleaning planning task, not only can cleaning resources be reasonably allocated to each area, but also a priority can be given to cleaning the area with more serious sanitation conditions, thereby improving the efficiency of collecting garbage and solving a technical problem caused by unreasonable cleaning planning that lead to a low efficiency of collecting garbage.

In the cleaning planning method provided in the embodiment of the present application, the environmental monitoring data of the area can reflect the sanitary status of the area, so the sanitary status level of each area can be predicted according to the environmental monitoring data, and the sanitary status level can reflect a severity of the sanitary status of the area. Since the cleaning resource information can reflect the available cleaning resources, the cleaning plan is generated by integrating the cleaning resource information and the sanitary status levels, which can not only reasonably allocate cleaning resources to each area, but also give the priority to cleaning the area with more serious sanitary status, thereby improving the efficiency of collecting garbage and solving the technical problem of the low efficiency of collecting garbage due to unreasonable cleaning planning.

As shown in FIG. 3, it is a diagram of functional modules of a cleaning planning apparatus provided in an embodiment of the present application. The cleaning planning apparatus 206 includes a collection module 2060, a prediction module 2061, a generation module 2062 and a push module 2063. The module/unit referred to in the present application refers to a series of computer-readable instruction segments that can be acquired by a processor 203 in FIG. 4 and can complete fixed functions, which are stored in the storage device 202 in FIG. 4. In this embodiment, the functions of each module/unit will be described in detail in subsequent embodiments.

The collection module 2060 is used to collect cleaning resource information and environmental monitoring data of multiple areas.

In some embodiments of the present application, the environmental monitoring data of each area includes one or more of environmental image data of each street in each area, real-time status data and historical status data of garbage in the garbage collection location on the streets.

The prediction module 2061 is used to predict the sanitation status level of each area based on the environmental monitoring data of each area.

In some embodiments of the present application, the prediction module 2061 is also used to extract features from the environmental monitoring data of each area based on a neural network model to obtain multiple features, determine a feature vector based on the multiple features, obtain the confidence levels corresponding to multiple preset sanitation levels for each area by predicting based on the feature vector, and determine the sanitation status level from the multiple preset sanitation levels based on the confidence levels.

In some embodiments of the present application, the prediction module 2061 is also used to obtain multiple environmental sample data and a label corresponding to each environmental sample data, where the label is used to indicate a preset sanitation level of each environmental sample data, and the prediction module 2061 is also used to train a preset neural network based on the multiple environmental sample data and the label corresponding to each environmental sample data to obtain the neural network model.

The generation module 2062 is used to generate the cleaning plan corresponding to the multiple areas according to the cleaning resource information and the sanitation status levels of the multiple areas.

In some embodiments of the present application, the generation module 2062 is also used to generate the cleaning planning task based on preset prompt information, the cleaning resource information and the sanitation status levels of the multiple areas, and the prompt information is used to prompt the generation of the cleaning plan based on the cleaning resource information and the sanitation status levels of the multiple areas, and the generation module 2062 is also used to input the cleaning planning task into the language model to obtain the cleaning plan.

In some embodiments of the present application, the generation module 2062 is also used to determine the cleaning planning information based on the semantic analysis of the cleaning planning task, where the cleaning planning information includes the cleaning order of the multiple areas, the cleaning resource information required by each area and/or the cleaning time information of each area, and the generation module 2062 is also used to generate the cleaning plan based on the cleaning planning information, where the cleaning resource information required by each area includes human resource information and/or tool resource information.

In some embodiments of the present application, the push module 2063 is used to determine a target cleaning plan from the multiple cleaning plans if there are multiple cleaning plans, and send the target cleaning plan to the terminal device.

As shown in FIG. 4, it is a schematic diagram of a structure of a cloud server provided in an embodiment of the present application. The cloud server 20 can be a device such as a mobile phone, a tablet computer, a notebook computer, or a computer. The embodiment of the present application does not impose any restrictions on a specific type of the cloud server.

As shown in FIG. 4, the cloud server 20 may include a communication module 201, a storage device 202, a processor 203, an input/output (I/O) interface 204, and a bus 205. The processor 203 is coupled to the communication module 201, the storage device 202, and the input/output interface 204 through the bus 205.

The communication module 201 may include a wired communication module and/or a wireless communication module. The wired communication module may provide a universal serial bus (USB), a controller area network (CAN) bus. The wireless communication module can provide a wireless fidelity (Wi-Fi), a Bluetooth (BT), a mobile communication network, a frequency modulation (FM), a near field wireless communication (near field communication, NFC) technology, an infrared (IR) technology and other wireless communication solutions.

The storage device 202 may include one or more random access memories (RAM) and one or more non-volatile memories (NVM). The RAM can be directly read and written by processor 203, and can be used to store executable programs (such as machine instructions) of other running programs, and can also be used to store user data and application data. The RAM can include a static random-access memory (SRAM), a dynamic random access memory (DRAM), a synchronous dynamic random access memory (SDRAM), a double data rate synchronous dynamic random access memory (DDR SDRAM) etc.

The non-volatile memory can also store executable programs, user data, and application data, etc., and can be loaded into the random access memory in advance for direct reading and writing by the processor 203. The non-volatile memory can include a disk storage device, a flash memory. For example, the flash memory may be a flash memory.

The storage device 202 is used to store one or more computer programs. The one or more computer programs are configured to be executed by the processor 203. The one or more computer programs include multiple instructions, and when the multiple instructions are executed by the processor 203, the cleaning planning method executed on the cloud server 20 can be implemented.

In other embodiments, the cloud server 20 shown in FIG. 4 further includes an external storage device interface for connecting to an external storage device to expand a storage capacity of the cloud server 20.

The processor 203 may include one or more processing units. For example, the processor 203 may include an application processor (AP), a modem processor, a graphics processing unit (GPU), an image signal processor (ISP), a controller, a video codec, a digital signal processor (DSP), and/or a neural-network processing unit (NPU), etc. Among them, different processing units can be independent devices or integrated in one or more processors.

The processor 203 provides computing and control capabilities. For example, the processor 203 is used to execute a computer program stored in the storage device 202 to implement the above-mentioned cleaning planning method.

The input/output interface 204 is used to provide a channel for user input or output. For example, the input/output interface 204 can be used to connect various input and output devices, such as a mouse, a keyboard, a touch device, a display screen, etc., so that the user can enter information or visualize information.

The bus 205 is at least used to provide a channel for a mutual communication among the communication module 201, the storage device 202, the processor 203, and the input/output interface 204 in the cloud server 20.

It is understood that the structure illustrated in the embodiment of the present application does not constitute a specific limitation on the cloud server 20. In other embodiments of the present application, the cloud server 20 may include more or fewer components than shown in the figure, or combine certain components, or split certain components, or arrange the components differently. The components shown in the figure may be implemented in hardware, software, or a combination of software and hardware.

An embodiment of the present application further provides a computer-readable storage medium, on which a computer program is stored. The computer program includes program instructions. The method implemented when the program instructions are executed can refer to the method in the above-mentioned embodiment of the present application.

The computer-readable storage medium may be an internal storage device of the electronic device described in the above embodiment, such as a hard disk or a memory of the electronic device. The computer-readable storage medium may also be an external storage device of the electronic device, such as a plug-in hard disk, a smart media card (SMC), a secure digital (SD) card, a flash card, etc. equipped on the electronic device.

In some embodiments, the computer-readable storage medium may include a program storage area and a data storage area, where the program storage area may store an operating system, an application required by at least one function, etc.; the data storage area may store data created according to the use of the electronic device, etc.

In several embodiments provided in this application, it should be understood that the disclosed systems, devices and methods can be implemented in other ways. For example, the device embodiments described above are only illustrative, for example, the division of the modules is only a logical function division, and there may be other division methods in actual implementation.

The modules described as separate components may or may not be physically separated, and the components shown as modules may or may not be physical units, that is, they may be located in one place or distributed on multiple network units. Some or all of the modules may be selected according to actual needs to achieve the purpose of the solution of this embodiment.

In addition, each functional module in each embodiment of the present application can be integrated into one processing unit, or each unit can exist physically separately, or two or more units can be integrated into one unit. The above integrated unit can be implemented in the form of hardware or in the form of hardware plus software functional modules.

Therefore, no matter from which point of view, the embodiments should be regarded as illustrative and non-restrictive, and the scope of the present application is limited by the appended claims rather than the above description, so it is intended that all changes falling within the meaning and scope of the equivalent elements of the claims are included in the present application. Any attached figure mark in the claims should not be regarded as limiting the claims involved.

In addition, it is clear that the word “comprising” does not exclude other units or steps, and the singular does not exclude the plural. Multiple units or devices stated in this application can also be implemented by one unit or device through software or hardware. The words first, second, etc. are used to indicate names, and do not indicate any particular order.

Finally, it should be noted that the above embodiments are only used to illustrate the technical solution of the present application and are not intended to limit it. Although the present application has been described in detail with reference to the preferred embodiments, a person of ordinary skill in the art should understand that the technical solution of the present application may be modified or replaced by equivalents without departing from the spirit and scope of the technical solution of the present application.

What is claimed is:

1. A cleaning planning method, comprising:
collecting cleaning resource information and environmental monitoring data of a plurality of areas to be cleaned;
predicting a sanitation status level of each of the plurality of areas based on the environmental monitoring data of each of the plurality of areas; and
generating at least one cleaning plan corresponding to the plurality of areas according to the cleaning resource information and the sanitation status level of each of the plurality of areas.

2. The cleaning planning method as described in claim 1, wherein the environmental monitoring data of each of the plurality of areas comprises one or more of environmental image data of a street of each of the plurality of areas, real-time status data and historical status data of garbage in a garbage collection location of the street.

3. The cleaning planning method according to claim 1, wherein predicting the sanitation status level of each of the plurality of areas based on the environmental monitoring data of each of the plurality of areas comprises:
for each of the plurality of areas, obtaining a plurality of features by performing a feature extraction on the environmental monitoring data of each of the plurality of areas using a neural network model;
determining a feature vector based on the plurality of features;
obtaining confidence levels corresponding to a plurality of preset sanitation levels for each of the plurality of areas by predicting based on the feature vector, and
determining the sanitation status level of each of the plurality of areas from the plurality of preset sanitation levels based on the confidence levels.

4. The cleaning planning method according to claim 3, further comprising:
training the neural network model, comprising:
acquiring a plurality of environmental sample data and a label corresponding to each of the plurality of environmental sample data, wherein the label indicates a preset sanitation level of each of the plurality of environmental sample data; and
obtaining the neural network model by training a preset neural network according to the plurality of environmental sample data and the label corresponding to each of the plurality of environmental sample data.

5. The cleaning planning method according to claim 1, wherein generating at least one cleaning plan corresponding to the plurality of areas according to the cleaning resource information and the sanitation status level of each of the plurality of areas comprises:
generating a cleaning planning task based on the cleaning resource information and the sanitation status levels of the plurality of areas; and
obtaining the at least one cleaning plan using a language model according to the cleaning planning task.

6. The cleaning planning method according to claim 5, wherein obtaining the at least one cleaning plan using the language model according to the cleaning planning task comprises:
determining cleaning planning information according to a semantic analysis of the cleaning planning task, wherein the cleaning planning information comprises at least one of a cleaning order of the plurality of areas, cleaning resource information required by each of the plurality of areas, and cleaning time information of each of the plurality of areas; and
generating the at least one cleaning plan according to the cleaning planning information, wherein the cleaning resource information required by each of the plurality of areas comprises at least one of human resource information and tool resource information.

7. The cleaning planning method according to claim 1, further comprising:
in response that the at least one cleaning plan comprises a plurality of cleaning plans, determining a target cleaning plan from the plurality of cleaning plans; and
sending the target cleaning plan to a terminal device.

8. An electronic device, comprising:
at least one processor; and
a storage device storing a computer program, which when executed by the at least one processor, cause the at least one processor to:
collect cleaning resource information and environmental monitoring data of a plurality of areas to be cleaned;
predict a sanitation status level of each of the plurality of areas based on the environmental monitoring data of each of the plurality of areas; and
generate at least one cleaning plan corresponding to the plurality of areas according to the cleaning resource information and the sanitation status level of each of the plurality of areas.

9. The electronic device as described in claim 8, wherein the environmental monitoring data of each of the plurality of areas comprises one or more of environmental image data of a street of each of the plurality of areas, real-time status data and historical status data of garbage in a garbage collection location of the street.

10. The electronic device according to claim 8, wherein the at least one processor predicts the sanitation status level of each of the plurality of areas based on the environmental monitoring data of each of the plurality of areas by:
for each of the plurality of areas, obtaining a plurality of features by performing a feature extraction on the environmental monitoring data of each of the plurality of areas using a neural network model;
determining a feature vector based on the plurality of features;
obtaining confidence levels corresponding to multiple preset sanitation levels for each of the plurality of areas by predicting based on the feature vector, and
determining the sanitation status level of each of the plurality of areas from the multiple preset sanitation levels based on the confidence levels.

11. The electronic device according to claim 10, wherein the at least one processor is further caused to:
train the neural network model, comprising:
acquiring multiple environmental sample data and a label corresponding to each of the multiple environmental sample data, wherein the label indicates a preset sanitation level of each of the plurality of environmental sample data; and
obtaining the neural network model by training a preset neural network according to the plurality of environmental sample data and the label corresponding to each of the plurality of environmental sample data.

12. The electronic device according to claim 8, wherein the at least one processor generates at least one cleaning plan corresponding to the plurality of areas according to the cleaning resource information and the sanitation status level of each of the plurality of areas by:
generating a cleaning planning task based on the cleaning resource information and the sanitation status levels of the plurality of areas; and
obtaining the at least one cleaning plan using a language model according to the cleaning planning task.

13. The electronic device according to claim 12, wherein the at least one processor obtains the at least one cleaning plan using the language model according to the cleaning planning task by:
determining cleaning planning information according to a semantic analysis of the cleaning planning task, wherein the cleaning planning information comprises at least one of a cleaning order of the plurality of areas, cleaning resource information required by each of the plurality of areas, and cleaning time information of each of the plurality of areas; and
generating the at least one cleaning plan according to the cleaning planning information, wherein the cleaning resource information required by each of the plurality of areas comprises at least one of human resource information and tool resource information.

14. The electronic device according to claim 8, wherein the at least one processor is further caused to:
in response that the at least one cleaning plan comprises a plurality of cleaning plans, determine a target cleaning plan from the plurality of cleaning plans; and
send the target cleaning plan to a terminal device.

15. A non-transitory storage medium having a computer program stored thereon, which when executed by a processor, a cleaning planning method is implemented, wherein the cleaning planning method comprises:
collecting cleaning resource information and environmental monitoring data of a plurality of areas that are to be cleaned;
predicting a sanitation status level of each of the plurality of areas based on the environmental monitoring data of each of the plurality of areas; and
generating at least one cleaning plan corresponding to the plurality of areas according to the cleaning resource information and the sanitation status level of each of the plurality of areas.

16. The non-transitory storage medium as described in claim 15, wherein the environmental monitoring data of each of the plurality of areas comprises one or more of environmental image data of a street of each of the plurality of areas, real-time status data and historical status data of garbage in a garbage collection location of the street.

17. The non-transitory storage medium according to claim 15, wherein predicting the sanitation status level of each of the plurality of areas based on the environmental monitoring data of each of the plurality of areas comprises:
for each of the plurality of areas, obtaining multiple features by performing a feature extraction on the environmental monitoring data of each of the plurality of areas using a neural network model;
determining a feature vector based on the plurality of features;
obtaining confidence levels corresponding to multiple preset sanitation levels for each of the plurality of areas by predicting based on the feature vector, and
determining the sanitation status level of each of the plurality of areas from the plurality of preset sanitation levels based on the confidence levels.

18. The non-transitory storage medium according to claim 17, further comprising:
training the neural network model, comprising:
acquiring multiple environmental sample data and a label corresponding to each of the plurality of environmental sample data, wherein the label indicates a preset sanitation level of each of the plurality of environmental sample data; and
obtaining the neural network model by training a preset neural network according to the plurality of environmental sample data and the label corresponding to each of the plurality of environmental sample data.

19. The non-transitory storage medium according to claim 15, wherein generating at least one cleaning plan corresponding to the plurality of areas according to the cleaning resource information and the sanitation status level of each of the plurality of areas comprises:
generating a cleaning planning task based on the cleaning resource information and the sanitation status levels of the plurality of areas; and
obtaining the at least one cleaning plan using a language model according to the cleaning planning task.

20. The non-transitory storage medium according to claim 19, wherein obtaining the at least one cleaning plan using the language model according to the cleaning planning task comprises:
determine cleaning planning information according to a semantic analysis of the cleaning planning task, wherein the cleaning planning information comprises at least one of a cleaning order of the plurality of areas, cleaning resource information required by each of the plurality of areas, and cleaning time information of each of the plurality of areas; and
generating the at least one cleaning plan according to the cleaning planning information, wherein the cleaning resource information required by each of the plurality of areas comprises at least one of human resource information and tool resource information.
